(19) United States
(12) Patent Application Publication
(10) Pub. No.: US 2024/0210956 A1
(43) Pub. Date: Jun. 27, 2024

(54) TETHER CONTROLLED DRONE

(71) Applicants: Shraddha Barawkar, Cincinnati, OH (US); Manish Kumar, Cincinnati, OH (US); Kelly Cohen, Mason, OH (US)

(72) Inventors: Shraddha Barawkar, Cincinnati, OH (US); Manish Kumar, Cincinnati, OH (US); Kelly Cohen, Mason, OH (US)

(21) Appl. No.: 18/425,574

(22) Filed: Jan. 29, 2024

Related U.S. Application Data
(63) Continuation-in-part of application No. 17/385,026, filed on Jul. 26, 2021, now abandoned.
(60) Provisional application No. 63/056,959, filed on Jul. 27, 2020.

(51) Int. Cl. G05D 1/49; B64U 10/60; G05D 109/20

(52) U.S. Cl. CPC G05D 1/49; B64U 10/60; B64U 2201/202; G05D 2109/20

(57) ABSTRACT

Systems, methods, and computer program products for controlling a drone using a tether. A drone is coupled to a distal end of the tether, and a force sensor measures one or more force parameters exerted on the drone by the tether. The force parameters are in turn used to generate control parameters, and the control parameters provided to a flight controller. The flight controller generates one or more propulsion parameters based on the control parameters, and provides the propulsion parameters to respective propulsion units of the drone. The drone can thereby be controlled by manipulating a proximate end of the tether, which changes the force parameters measured by the force sensor.

### CROSS-REFERENCE TO RELATED APPLICATIONS

This application claims the benefit of U.S. application Ser. No. 17/385,026, filed on Jul. 26, 2021, entitled “Tether Controlled Drone” claiming the benefit of U.S. Application No. 63/056,959, filed on Jul. 27, 2020, entitled “Tether Controlled Drone”, the disclosures of which are each incorporated by reference herein in their entireties.

### GOVERNMENT RIGHTS

This invention was made with government support under contract number 1526677 awarded by the National Science Foundation. The Government has certain rights in this invention.

### FIELD OF THE INVENTION

The present invention relates generally to drone aircraft design, and in particular, to a drone that is controlled by an operator through manipulation of a tether operatively coupled to the drone.

### BACKGROUND

The uses of Unmanned Aerial Vehicles (UAVs), or “drones”, have increased greatly in recent years. Safety is often a high priority with drones, whether they are being flown autonomously or by utilizing a remote radio controller. Unlike free-flying drones, tethered drones include a permanent physical link, such as a flexible wire or cable. Power may be provided to the drone through the tether so that tethered drones can remain aloft much longer than free-flying drones. Because the tether limits the space in which the drone can operate, tethered drones are considered safer to fly than free-flying drones. In addition to power, the tether may be configured to carry data from the drone to other devices. Tethered drones thus find use in numerous applications that require prolonged flight time and large data transfers, such as video streaming of a rescue operation.

Tethered drone systems are commonly used for airborne intelligence, surveillance, and reconnaissance (ISR). ISR systems are often utilized by military, homeland security, and first responders for emergency scenarios. Because a tethered drone can be powered via the tether, they have an essentially unlimited flight time. Tethered drones have also demonstrated the ability to fly in strong winds up to 200 ft. above ground level. Some tethered drone systems also allow effective data communication between the drone and a base station, and may include an onboard battery as a power backup in the event tether power is lost.

As the use of drones continues to expand, there is a demand for improvement in both the safety and controllability of drones. Thus, there is a need for improved systems, methods, and computer program products for operating tethered drones.

### SUMMARY

In an embodiment of the invention, a system for controlling a drone is provided. The system includes a tether having a proximal end and a distal end operatively coupled to the drone, a force sensor that measures a force parameter exerted on the drone by the tether, one or more processors, and a memory coupled to the one or more processors. The memory includes program code that, when executed by the one or more processors, causes the one or more processors to receive a signal from the force sensor indicative of the force parameter, and control at least one of an attitude and a position of the drone based at least in part on the force parameter.

In an aspect of the invention, the program code may cause the one or more processors to control the at least one of the attitude and the position of the drone by generating a control parameter based at least in part on the force parameter, and providing the control parameter to a flight control module.

In another aspect of the invention, the control parameter may be one of a roll angle, a roll rate, a pitch angle, a pitch rate, a yaw angle, a yaw rate, and an amount of thrust.

In another aspect of the invention, the system may further include a propulsion unit, and the flight control module may generate a propulsion parameter based on the control parameter and provide the propulsion parameter to the propulsion unit.

In another aspect of the invention, the system may further include an attitude-position-velocity module, and the program code may cause the one or more processors to control the at least one of the attitude and the position of the drone by determining the attitude, the position, or both the attitude and the position of the drone relative to an Earth-fixed reference frame, and correcting for an effect of the attitude, the position, or both the attitude and the position of the drone on the force parameter.

In another aspect of the invention, the system may further include the attitude-position-velocity module, and the program code may cause the one or more processors to control the at least one of the attitude and the position of the drone by determining the attitude, the position, or both the attitude and the position of the drone relative to an Earth-fixed reference frame, generating a corrected force parameter that accounts for the effect of the attitude, the position, or both the attitude and the position of the drone on the force parameter, and generating the control parameter based at least in part on the corrected force parameter.

In another aspect of the invention, the system may further include a propulsion unit, and the program code may further cause the one or more processors to control the at least one of the attitude and the position of the drone by generating a propulsion parameter based on the control parameter, and providing the propulsion parameter to the propulsion unit.

In another aspect of the invention, the system may further include a ground unit that provides power to the drone through the tether.

In another aspect of the invention, the ground unit may receive data from the drone through the tether.

In another aspect of the invention, the ground unit may transmit the data received from the drone to a user device.

In another embodiment of the invention, a method of controlling the drone is provided. The method includes manipulating the proximal end of the tether having its distal end operatively coupled to the drone, measuring the force parameter exerted on the drone by the tether, and controlling at least one of the attitude and the position of the drone based at least in part on the force parameter.

In an aspect of the invention, controlling the at least one of the attitude and the position of the drone may include generating the control parameter based at least in part on the force parameter, and providing the control parameter to the flight control module.

In another aspect of the invention, the method may further include generating the propulsion parameter based on the control parameter, and providing the propulsion parameter to the propulsion unit of the drone.

In another aspect of the invention, the method may further include determining the attitude, the position, or both the attitude and the position of the drone relative to the Earth-fixed reference frame, and correcting for the effect of the attitude, the position, or both the attitude and the position of the drone on the force parameter.

In another aspect of the invention, correcting for the effect of the attitude, the position, or both the attitude and the position of the drone on the force parameter may include generating the corrected force parameter that accounts for the effect of the attitude, the position, or both the attitude and the position of the drone on the force parameter, and generating the control parameter based at least in part on the corrected force parameter.

In another aspect of the invention, the method may further include providing power to the drone through the tether.

In another aspect of the invention, the method may further include receiving data from the drone through the tether.

In another aspect of the invention, the method may further include transmitting the data received from the drone to the user device.

In another embodiment of the invention, a computer program product is provided. The computer program product includes a non-transitory computer-readable storage medium, and program code stored on the non-transitory computer-readable storage medium. The program code is configured so that, when executed by one or more processors, the program code causes the one or more processors to measure the force parameter exerted on the drone by the tether, and control at least one of the attitude and the position of the drone based at least in part on the force parameter.

The above summary presents a simplified overview of some embodiments of the invention to provide a basic understanding of certain aspects of the invention discussed herein.

The summary is not intended to provide an extensive overview of the invention, nor is it intended to identify any key or critical elements, or delineate the scope of the invention. The sole purpose of the summary is merely to present some concepts in a simplified form as an introduction to the detailed description presented below.

### BRIEF DESCRIPTION OF THE DRAWINGS

The accompanying drawings, which are incorporated in and constitute a part of this specification, illustrate various embodiments of the invention and, together with the general description of the invention given above, and the detailed description of the embodiments given below, serve to explain the embodiments of the invention.

FIGS. 1A and 1B are a diagrammatic views of exemplary operating environments including a tethered drone.

FIG. 2 is a diagrammatic view illustrating relationships between the drone of

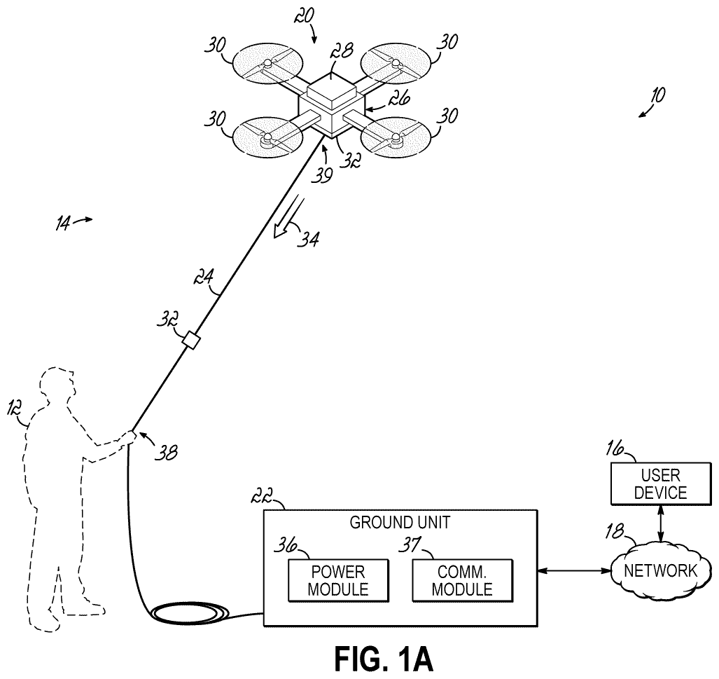

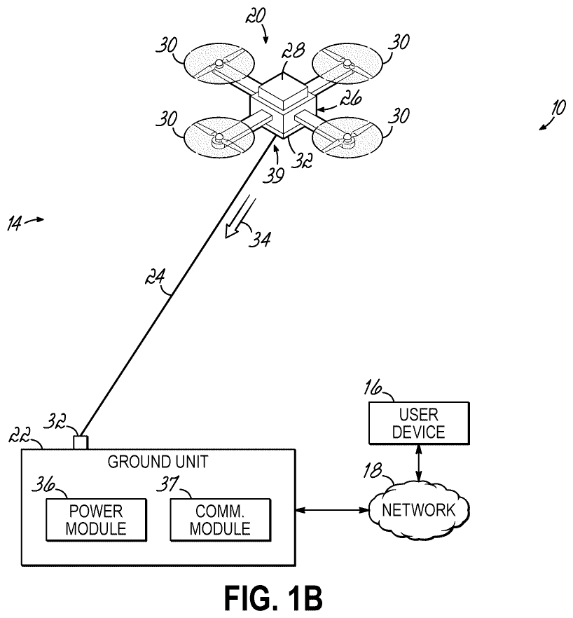

FIGS. 1A and 1B, an Earth-fixed reference frame, and a drone-fixed reference frame.

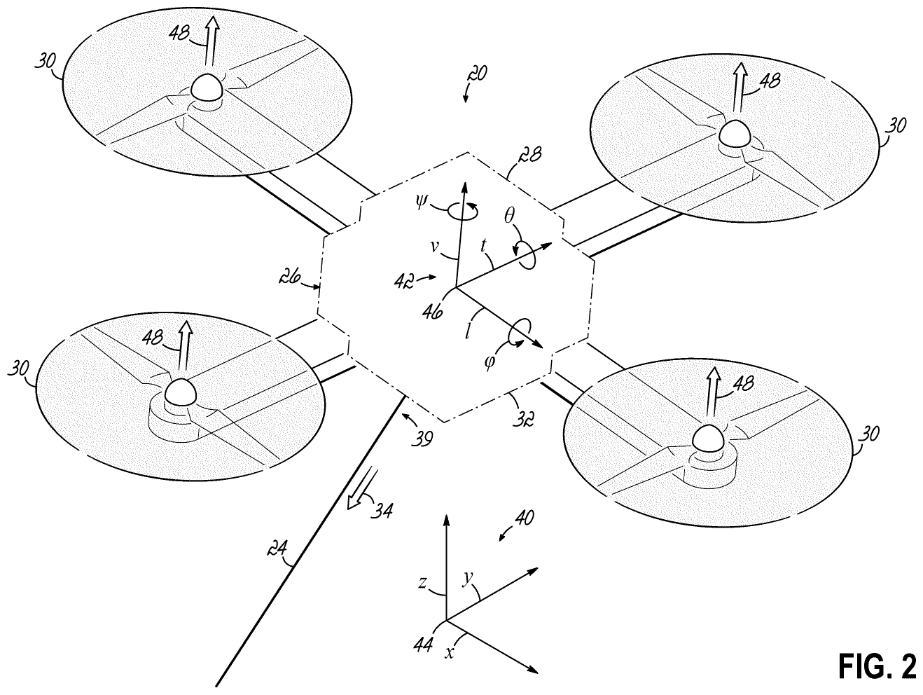

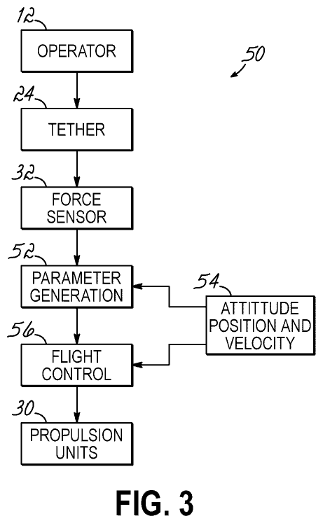

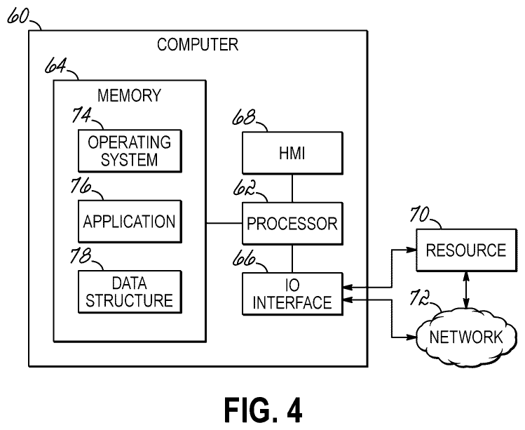

FIG. 3 is a flowchart of a system or process for controlling the drone of FIGS. 1A, 1B, and 2 using the tether.

FIG. 4 is a diagrammatic view of a computer that may be used to implement one or more of the components or processes shown in FIGS. 1A-3.

It should be understood that the appended drawings are not necessarily to scale, and may present a somewhat simplified representation of various features illustrative of the basic principles of the invention. The specific design features of the sequence of operations disclosed herein, including, for example, specific dimensions, orientations, locations, and shapes of various illustrated components, may be determined in part by the particular intended application and use environment. Certain features of the illustrated embodiments may have been enlarged or distorted relative to others to facilitate visualization and a clear understanding.

### DETAILED DESCRIPTION

As used herein, the term “drone” refers to any aerodyne, aerostat, or other type of aerial vehicle or aircraft, including but not limited to, single or multi-rotor rotorcraft, fixed wing aircraft, and airships. Embodiments of the present invention actively control the attitude and position of a tethered drone via physical manipulation of the tether, e.g., by applying force to the tether through changes in one or both the tension applied to, and the position of, a proximal end of the tether. Tethered control allows easy operation of the drone without the need to learn how to fly the drone using a drone controller, and complements the improved safety and indefinite flight time provided by tethered drones. The tether based control system includes a force sensor that measures the force exerted by the tether on one or more of the drone, an operator of the drone, or a ground unit. The magnitude and direction of the force measured by the force sensor may then be used to control the attitude and position of the drone. Thus, the drone can be flown by manipulating a proximal end of the tether.

Force parameters measured by the force sensor may be provided to a controller (e.g., onboard the drone) that executes a control algorithm. The control algorithm may generate control parameters based on the force parameters. The control parameters may then be provided to an autopilot system. The drone may thereby be controlled according to the measured force. A hybrid position/force control scheme may be used to implement compliance with the control inputs provided through the tether. For example, position control may be used when hovering, and force control may be used when moving. The balance between position and force control schemes may stabilize the drone during wind disturbances. Fuzzy logic and admittance based control schemes may be used to achieve force-based control, and an onboard computer may be used to implement the computationally extensive hybrid position-force control.

Referring now to the figures, FIGS. 1A and 1B depict exemplary operating environments 10 each including one or more of a drone operator 12, a tethered drone system 14, and a user system 16. The tethered drone system 14 may include a drone 20, a ground unit 22, and a tether 24 that operably couples the drone 20 to the ground unit 22. The user system 16 may receive data from the tethered drone system 14 via a communication network 18. The received data may include telemetry, a video stream, or any other data that can be transmitted by a drone, and the user system 16 may display the received data to a system user. The ground unit 22 may be stationary or mobile, e.g., attached to or integrated with a vehicle.

The drone 20 may include a body 26, a control unit 28, one or more propulsion units 30, and a force sensor 32. One or more force sensors 32 may also be located along the tether 24 or in/on the ground unit 22. The one or more force sensors 32 along the tether 24 or associated with the ground unit 22 may supplement the force sensor 32 in the drone 20. In other embodiments, the force sensor 32 along the tether 24 or associated with the ground unit 22 may allow the force sensor 32 in the drone 20 to be omitted. Advantageously, omitting the force sensor 32 from the drone 20 may reduce the mass of the drone 20. The control unit 28 may be operatively coupled to the propulsion units 30 and force sensor 32. The control unit 28 may receive one or more signals from the force sensor 32 indicative of a force vector 34 exerted on the drone 20 by the tether 24, exerted on the drone operator 12 by the tether 24, or exerted on the ground unit 22 by the tether 24, and transmit one or more signals to the propulsion units 30 to control movement of the drone 20. Each propulsion unit 30 may include a motor driven propeller, a turbine, or other suitable device that generates a controllable amount of thrust.

The force sensor 32 may include a multi-axis force transducer that measures one or more forces (e.g., Fₓ, F_{y}, F_{z}) exerted by the tether 24 on the drone operator 12, the drone 20, or the ground unit 22, as the case may be. The force sensor 32 may convert each of the measured force parameters into an electrical output signal, e.g., a voltage or digital data signal. Based on the received signals, the control unit 28 may determine one or more components of the force vector 34, such as the magnitude and direction of the force vector 34. The control unit 28 may then compare the components of force vector 34 to one or more force parameter thresholds, settings, or ranges. Based on this comparison, the control unit 28 may adjust the position of the drone 20 using the propulsion units 30.

The ground unit 22 may include a power module 36 and a communication module 37. The power module 36 may be configured to provide one or both of the drone 20 and ground unit 22 with power from a power source, such as a battery, solar cells, or an external power source (e.g., a generator or the power grid). The communication module 37 may be configured to receive data from the drone 20, and transmit the received data to the user system 16, either directly or over the network 18. In an alternative embodiment of the invention, the drone 20 may include a power source, a communication module, or both a power source and a communication module. In this case, the drone 20 may be controlled by the tether 24, but be self-powered and communicate with the user system 16 either directly or through the network 18 without the need for the ground unit 22.

The tether 24 may include a proximal end 38 that is held by the operator 12 (FIG. 1A) or operatively coupled to the ground unit 22, either directly or by a respective force sensor 32 (FIG. 1B), and a distal end 39 which is operatively coupled to the drone 20, either directly or by a respective force sensor 32. The tether 24 may also include one or more conductors (e.g., copper wires) that operatively couple power from the ground unit 22 to the drone 20. For embodiments in which the drone receives or transmits data over the tether 24, communication signals may be carried by the conductors that supply power to the drone 20, or the tether 24 may include additional conductors configured to carry electrical communication signals. The tether 24 may also include an optical fiber or other physical link configured to carry communication signals. These communication signals may include signals indicative of a force sensed by a force sensor 32 or signals for controlling the drone 20 generated based on the force sensed by the force sensor 32.

FIG. 2 depicts the drone 20, an Earth-fixed reference frame 40, and a drone-fixed reference frame 42. Although not depicted, in certain embodiments, there may also be a ground unit-fixed reference frame associated with the ground unit 22. The ground unit-fixed reference frame may have a similar relationship to the Earth-fixed reference frame 40 as the drone-fixed reference frame 42, only with respect to the ground unit 22. Each reference frame may be defined in three-dimensional space by a set of three mutually orthogonal unit-length direction vectors. For example, the Earth-fixed reference frame 40 may be defined by a set of unit-length direction vectors x, y, z intersecting at an origin 44, and can be considered an inertial frame. The Earth-fixed reference frame 40 may, for example, have its x-axis oriented toward the north, its y-axis oriented toward the west, and its z-axis oriented in an upward direction, although other orientations can be used. The origin 44 of Earth-fixed reference frame 40 may be defined as a fixed point P₀=[0, 0, 0] on Earth's surface if needed for purposes of tracking the position of the drone 20.

The drone-fixed reference frame 42 may also be defined by a set of unit-length direction vectors, and moves relative to the Earth-fixed reference frame 40 as the drone 20 changes its attitude and position. The unit-length vectors of the drone-fixed reference frame 42 may include a longitudinal or l-axis oriented in a forward direction through the body 26 of drone 20, and a transverse or t-axis orthogonal to the l-axis and oriented in a leftward direction through the body 26 of drone 20. The l and t-axes may thereby define a plane which is horizontal during level flight of the drone 20. A vertical or v-axis of the drone-fixed reference frame 42 may be orthogonal to both the l and t-axes and oriented in an upward direction during level flight. Thus, like the x, y, and z-axes of the Earth-fixed reference frame 40, the l, t, and v-axes of the drone-fixed reference frame 42 may form a right-handed coordinate system. The origin 46 of the drone-fixed reference frame 42 may be located at the center of gravity of the drone 20 (shown), at the point where the tether 24 is attached to the drone 20 (e.g., attached to the force sensor 32), or any other suitable point in, on, or proximate to the drone 20.

Each of the propulsion units 30 may be configured to produce a thrust vector 48 which is controlled by the control unit 28. The magnitude of each thrust vector 48 may be controlled, for example, by controlling the angular velocity ω of a motor that drives propellers of the propulsion unit 30. Other methods of controlling the thrust vectors 48 may include adjusting the blade pitch of the propeller, controlling an amount of fuel provided to an engine of the propulsion unit 30, or any other suitable method. The orientation of the thrust vectors 48 may be changed by altering the orientation of the drone 20, rotating the propulsion unit 30 about one or more axes, adjusting the position of an airfoil or vane, or any other suitable method.

Rotation of the drone 20 about the l-axis may be referred to as roll. A positive rolling motion may lift the port side relative to the starboard side of the drone 20. A negative rolling motion may lift the starboard side relative to the port side of the drone 20. Positive roll may be induced by one of or both increasing the thrust vector 48 of propulsion units 30 on the port side of the l-axis and decreasing the thrust vector 48 of propulsion units 30 and the starboard side of the l-axis. Negative roll may be induced by one of or both increasing the thrust vector 48 of propulsion units 30 on the starboard side of the l-axis and decreasing the thrust vector 48 of propulsion units 30 and the port side of the l-axis. A non-zero roll angle φ may cause the sum of the thrust vectors 48 to have a transverse component that, absent an opposing force (e.g., a cross-wind), causes the drone to move in a transverse direction.

Rotation of the drone 20 about the t-axis may be referred to as pitch. A positive pitching motion may raise the front of drone 20 relative to the rear of drone 20. A negative pitching motion may lower the front of drone 20 relative to the rear of drone 20. Positive pitch may be induced by one of or both increasing the thrust vector 48 of propulsion units 30 forward of the t-axis and decreasing the thrust vector 48 of propulsion units 30 rearward of the t-axis. Negative pitch may be induced by one of or both increasing the thrust vector 48 of propulsion units 30 rearward of the t-axis and decreasing the thrust vector 48 of propulsion units 30 forward of the t-axis. A non-zero pitch angle θ may cause the sum of the thrust vectors 48 to have a longitudinal component that, absent an opposing force (e.g., a head or tail-wind), causes the drone 20 to move in a longitudinal direction.

Rotation of the drone 20 about the v-axis may be referred to as yaw. A positive yawing motion may rotate the front of drone 20 toward the starboard side. A negative yawing motion may rotate the front of drone 20 toward the port side. Yaw may be induced by changing the speed of one or more rotors of the propulsion units 30 so that the sum of the yaw generated by the propulsion units 30 is non-zero, e.g., by slowing a pair of diagonally-opposed propellers spinning in a one direction and increasing the speed of another pair of diagonally-opposed propellers spinning in the opposite direction from the first pair. The direction in which the drone is pointed may be adjusted by changing the yaw angle ψ.

The total thrust of the drone may be the sum of the thrust vectors 48 of each of the propulsion units. Changes in total thrust may be made to maintain a vertical force sufficient to keep the drone aloft in response to changes in the roll and pitch angles φ, θ, to alter the altitude or velocity of the drone, to counteract changes in wind velocity or load, or for any other suitable reason.

It should be understood that the above described drone 20 is for exemplary purposes only, and any suitable drone may be controlled in accordance with embodiments of the invention. For example, suitable drones may have any number or configuration of propulsion units, and may include any suitable flight control mechanism (e.g., ailerons, elevators, rudders, flaps, slats, spoilers, etc.) for use in controlling the attitude and position of the drone.

FIG. 3 depicts a block diagram illustrating an exemplary system 50 for controlling the drone 20 with the tether 24. The operator 12 may provide commands to the 20 drone by manipulating the proximal end 38 of tether 24, either directly or through movement of the ground unit 22. These inputs may include increasing, decreasing, or maintaining the magnitude of the force vector 34 by increasing, decreasing, or maintaining the amount of tension applied to the proximal end of the tether 24. The proximal end 38 of tether 24 may also move vertically and horizontally in response to movement by the operator 12 or ground unit 22. Movement of the proximal end 38 of tether 24 may alter one or more of a direction and magnitude of the force vector 34 as measured by the force sensor 32.

The force sensor 32 may comprise a multi-axis (e.g., six-axis) force sensor, or any other suitable device that measure forces in each of plurality of directions. For example, the force sensor 32 may detect one or more of three force components, e.g., force components aligned with each of the l, t, and v-axes of the drone-fixed reference frame, or analogous axes associated with a fixed reference frame of the operator 12 or ground unit 22. These force parameters may be converted to electrical signals (e.g., voltage levels or digital data) that are transmitted to a parameter generation module 52.

The parameter generation module 52 may receive the force parameters from the force sensor 32, and generate control parameters suitable for controlling the drone 20 based thereon. Suitable control parameters may include one or more of, but are not limited to, roll angle φ, roll rate \dot{φ}, pitch angle θ, pitch rate \dot{θ}, yaw angle ψ, yaw rate \dot{ψ}, and total thrust F_{T}.

Changes in the position or orientation of the drone-fixed reference frame 42 relative to the Earth-fixed reference frame 40 may occur due to changes in roll angle φ, pitch angle θ, yaw angle ψ, and drone position P_{D}=[x_{D}, y_{D}, z_{D}]. These changes in the relative attitude and position of the drone-fixed reference frame 42 may result in corresponding changes to the force parameters received from the force sensor 32 that are not due (at least directly) to input from the operator 12 or changes in the position or orientation of the ground unit 22.

To prevent changes in the relative attitude and position of the drone-fixed reference frame 42 from impacting generation of the control parameters, the parameter generation module 52 may receive one or more signals from an Attitude-Position-Velocity (APV) module 54. These signals may be indicative of one or more of the attitude, position, and velocity of the drone 20 relative to the Earth-fixed reference frame 40. The APV module 54 may be operatively coupled to the drone 20, and may include one or more of an Inertial Measurement Unit (IMU), Global Positioning System (GPS) receiver, or other device that can determine one or more of the attitude, position, and velocity of the drone 20.

Based on data received from the APV module 54, the parameter generation module 52 may correct for the effect of changes in the attitude and position of the drone 20 on the force vector 34 measured by the force sensor 32. This correction may include, for example, subtracting roll, pitch, and yaw angles φ, θ, ψ measured by the APV module 54 from corresponding angular components of the force vector 34. Correction for changes in the force vector 34 caused by changes in the position of the drone 20 relative to the Earth-fixed reference frame 40 may also be implemented by the parameter generation module 52. The corrected force parameters may then be used to generate the control parameters.

The flight control module 56 may receive the control parameters and generate propulsion parameters based thereon. The propulsion parameters may include a rotor speed setting or any other setting that controls the amount or direction of thrust provided by the propulsion unit 30. The flight control module 56 may also receive attitude, position, or velocity data from the APV module 54. The flight control module 56 may compare one or more of the measured attitude, position, and velocity of the drone 20 to one or more of a target attitude, a target position, and a target velocity generated from the control parameters. Any error signals generated by this comparison may be provided to one or more control algorithms (e.g., a proportional-integral-derivative control algorithm) that in turn adjust the control signals provided to the propulsion units 30 to correct the error.

The parameter generation module and flight control modules 52, 56 may comprise one or more programs executed by the control unit 28 or by one or more other or additional computers, one or more application-specific hardware modules (e.g., an onboard computer or fuzzy-logic/admittance controller), or any other suitable device configured to perform the above described functions. These devices may be located in the drone 20, the ground unit 22, or any other suitable location.

Embodiments of the invention may allow an operator to completely control a tethered drone to fly in any direction desired. The drone may follow and coordinate with movements of the operator or ground unit based on forces exerted on the drone by the tether. In this way, the response of the drone may be considered analogous to flying a kite. In the absence of any application of force by the operator or ground unit, the drone may be configured to remain at a fixed position relative to an inertial reference frame. Through appropriate design of the controller, the drone may be resistant to instabilities caused by tether influenced wind disturbances.

Embodiments of the invention may also provide an additional layer of safety to tethered drone systems. For example, in case of an emergency or worst case scenario, the operator may control the drone by pulling the drone down via the tether. The drone may sense the downward force applied by the operator or ground unit, and come down in response thereto. The above described systems may allow full human control of a drone rather than using a remote controller or an autonomous drone, each of which may pose greater risks than a tethered drone. This improved safety feature may provide a further advantage over known drone systems in addition to the intuitive control provided by the tether based control interface. Variable admittance control may also be utilized to improve system performance and allow the system to be more responsive to operator inputs during varying operational conditions. Under this approach, the control parameters may be automatically tuned based on contact force and rate of change of force.

Applications of tether controlled drones may include, but are not limited to, traffic monitoring, space applications, ad-hoc cellular networks, exploration in open waters, hobbies, and the military. Traffic monitoring typically requires longer operation for which tether controlled drones are ideal. Tether controlled drones may allow movement to find an optimal spot for effective monitoring, and can be easily attached to a moving car or other vehicle to monitor traffic. On the surface of other planets, there are fewer obstacles, such as trees, bridges, and buildings. Thus, a tether controlled drone could be attached to a moving rover in order to provide a look-ahead capability for improved navigation and more effective exploration. Tether controlled drones could also be used to set up an ad-hoc cellular network or local wireless internet during events, disasters, or emergency scenarios. A swarm of tether controlled drones carrying communication equipment could provide mobility for better coverage and connectivity. In open waters, a tether controlled drone could be attached to a ship to provide wider surveillance capability in oceans, and could be used to locate spills or spot fish. Hobbies in which tether controlled drones could be effective include aerial photography or videography while in motion. For example, a tether controlled drone could be attached to a skier or used for skateboarding and other sports. A tether controlled drone could also be advantageous as a children's toy due to improved safety and lower cost than other types of drones. Tether controlled drones may also be deployed on a battlefield, e.g., by attaching drones to vehicles to provide a bird's eye view of the terrain to the soldiers to spot Improvised Explosive Devices (IEDs) or other threats from a distance.

Referring now to FIG. 4, embodiments of the invention described above, or portions thereof, may be implemented using one or more computer devices or systems, such as exemplary computer 60. The computer 60 may include a processor 62, a memory 64, an input/output (I/O) interface 66, and a Human Machine Interface (HMI) 68. The computer 60 may also be operatively coupled to one or more external resources 70 via a network 72 or the I/O interface 66. External resources may include, but are not limited to, servers, databases, mass storage devices, peripheral devices, cloud-based network services, or any other resource that may be used by the computer 60.

The processor 62 may include one or more devices that manipulate signals (analog or digital) or otherwise performs operations based on operational instructions stored in memory 64. Memory 64 may include one or more volatile or non-volatile memory devices that are capable of storing data. The processor 62 may operate under the control of an operating system 74 that resides in memory 64. The operating system 74 may manage computer resources so that computer program code embodied as one or more computer software applications, such as an application 76 residing in memory 64, can have instructions executed by the processor 62. The processor 62 may also execute the application 76 directly, in which case the operating system 74 may be omitted. One or more data structures 78 may also reside in memory 64, and may be used by the processor 62, operating system 74, or application 76 to store or manipulate data.

The I/O interface 66 may provide a machine interface that operatively couples the processor 62 to other devices and systems, such as sensors, motors, the external resource 70 or the network 72. The application 76 may thereby work cooperatively with the external resource 70, network 72, or other components by communicating via the I/O interface 66 to provide the various features, functions, applications, processes, or modules comprising embodiments of the invention. The application 76 may also have program code that is executed by one or more external resources 70, or otherwise rely on functions or signals provided by other system or network components external to the computer 60. Indeed, given the nearly endless hardware and software configurations possible, persons having ordinary skill in the art will understand that embodiments of the invention may include applications that are located externally to the computer 60, distributed among multiple computers or other external resources 70, or provided by computing resources (hardware and software) that are provided as a service over the network 72, such as a cloud computing service.

The HMI 68 may be operatively coupled to the processor 62 of computer 60 to allow a user to interact directly with the computer 60. The HMI 68 may include video or alphanumeric displays, a touch screen, a speaker, and any other suitable audio and visual indicators capable of providing data to the user. The HMI 68 may also include input devices and controls such as an alphanumeric keyboard, a pointing device, keypads, pushbuttons, control knobs, microphones, etc., capable of accepting commands or input from the user and transmitting the entered input to the processor 62.

In general, the routines executed to implement the embodiments of the invention, whether implemented as part of an operating system or a specific application, component, program, object, module or sequence of instructions, or a subset thereof, may be referred to herein as “computer program code,” or simply “program code.” Program code typically comprises computer-readable instructions that are resident at various times in various memory and storage devices in a computer and that, when read and executed by one or more processors in a computer, cause that computer to perform the operations necessary to execute operations or elements embodying the various aspects of the embodiments of the invention. Computer-readable program instructions for carrying out operations of the embodiments of the invention may be, for example, assembly language, source code, or object code written in any combination of one or more programming languages.

Various program code described herein may be identified based upon the application within which it is implemented in specific embodiments of the invention. However, it should be appreciated that any particular program nomenclature which follows is used merely for convenience, and thus the invention should not be limited to use solely in any specific application identified or implied by such nomenclature. Furthermore, given the generally endless number of manners in which computer programs may be organized into routines, procedures, methods, modules, objects, and the like, as well as the various manners in which program functionality may be allocated among various software layers that are resident within a typical computer, it should be appreciated that the embodiments of the invention are not limited to the specific organization and allocation of program functionality described herein.

The program code embodied in any of the applications/modules described herein is capable of being individually or collectively distributed as a computer program product in a variety of different forms. In particular, the program code may be distributed using a computer-readable storage medium having computer-readable program instructions thereon for causing a processor to carry out aspects of the embodiments of the invention.

Computer-readable storage media, which is inherently non-transitory, may include volatile and non-volatile, and removable and non-removable tangible media implemented in any method or technology for storage of data, such as computer-readable instructions, data structures, program modules, or other data. Computer-readable storage media may include any medium that can be used to store data and which can be read by a computer. A computer-readable storage medium should not be construed as transitory signals per se (e.g., radio waves or other propagating electromagnetic waves, electromagnetic waves propagating through a transmission media such as a waveguide, or electrical signals transmitted through a wire). Computer-readable program instructions may be downloaded to a computer, another type of programmable data processing apparatus, or another device from a computer-readable storage medium or to an external computer or external storage device via a network.

The flowcharts and block diagrams depicted in the figures illustrate the architecture, functionality, or operation of possible implementations of systems, methods, or computer program products according to various embodiments of the invention. In this regard, each block in the flowchart or block diagrams may represent a module, segment, or portion of instructions, which comprises one or more executable instructions for implementing the specified logical function or functions.

In certain alternative embodiments, the functions, acts, or operations specified in the text of the specification, the flowcharts, sequence diagrams, or block diagrams may be re-ordered, processed serially, or processed concurrently consistent with embodiments of the invention. Moreover, any of the flowcharts, sequence diagrams, or block diagrams may include more or fewer blocks than those illustrated consistent with embodiments of the invention. It should also be understood that each block of the block diagrams or flowcharts, or any combination of blocks in the block diagrams or flowcharts, may be implemented by a special purpose hardware-based system configured to perform the specified functions or acts, or carried out by a combination of special purpose hardware and computer instructions.

The terminology used herein is for the purpose of describing particular embodiments only and is not intended to be limiting of the embodiments of the invention. As used herein, the singular forms “a”, “an” and “the” are intended to include both the singular and plural forms, and the terms “and” and “or” are each intended to include both alternative and conjunctivecombinations, unless the context clearly indicates otherwise. It will be further understood that the terms “comprises” or “comprising,” when used in this specification, specify the presence of stated features, integers, actions, steps, operations, elements, or components, but do not preclude the presence or addition of one or more other features, integers, actions, steps, operations, elements, components, or groups thereof. Furthermore, to the extent that the terms “includes”, “having”, “has”, “with”, “comprised of”, or variants thereof are used in either the detailed description or the claims, such terms are intended to be inclusive in a manner similar to the term “comprising”.

While all the invention has been illustrated by a description of various embodiments, and while these embodiments have been described in considerable detail, it is not the intention of the Applicant to restrict or in any way limit the scope of the appended claims to such detail. Additional advantages and modifications will readily appear to those skilled in the art. The invention in its broader aspects is therefore not limited to the specific details, representative apparatus and method, and illustrative examples shown and described. Accordingly, departures may be made from such details without departing from the spirit or scope of the Applicant's general inventive concept.

What is claimed is:

1. A system for controlling a drone, comprising:
a tether having a proximal end and a distal end operatively coupled to the drone;
a multi-axis force sensor that measures a force parameter exerted by the tether in each of three mutually orthogonal axes of a fixed reference frame;
one or more processors; and
a memory coupled to the one or more processors and including program code that, when executed by the one or more processors, causes the one or more processors to:
receive one or more signals from the multi-axis force sensor indicative of the force parameter exerted by the tether in each of the three mutually orthogonal axes;
generate one or more control parameters based at least in part on each force parameter; and
provide the one or more control parameters to a flight control module to control at least one of an attitude and a position of the drone based at least in part on the one or more control parameters.

2. The system of claim 1, wherein the one or more control parameters include one or more of a roll angle, a roll rate, a pitch angle, a pitch rate, a yaw angle, a yaw rate, and an amount of thrust.

3. The system of claim 1, further comprising:
a propulsion unit,
wherein the flight control module generates a propulsion parameter based on the one or more control parameters, and provides the propulsion parameter to the propulsion unit.

4. The system of claim 1, further comprising:
an attitude-position-velocity module,
wherein the program code causes the one or more processors to control the at least one of the attitude and the position of the drone by:
determining the attitude, the position, or both the attitude and the position of the drone relative to an Earth-fixed reference frame, and
correcting for an effect of the attitude, the position, or both the attitude and the position of the drone on the force parameters.

5. The system of claim 4, wherein the program code causes the one or more processors to control the at least one of the attitude and the position of the drone using a control scheme that controls the drone based on the position of the drone relative to the Earth-fixed reference frame when the drone is hovering, and that controls the drone based on the force parameters exerted on the drone in each of the three mutually orthogonal axes when the drone is moving.

6. The system of claim 1, further comprising:
an attitude-position-velocity module,
wherein the program code causes the one or more processors to control the at least one of the attitude and the position of the drone by:
determining the attitude, the position, or both the attitude and the position of the drone relative to an Earth-fixed reference frame,
generating one or more corrected force parameters that account for an effect of the attitude, the position, or both the attitude and the position of the drone on the force parameters, and
generating the one or more control parameters based at least in part on the one or more corrected force parameters.

7. The system of claim 6, further comprising:
a propulsion unit,
wherein the program code further causes the one or more processors to control the at least one of the attitude and the position of the drone by:
generating a propulsion parameter based on the one or more control parameters, and
providing the propulsion parameter to the propulsion unit.

8. The system of claim 1, wherein the fixed reference frame is a drone-fixed reference frame, and the force parameter exerted by the tether is exerted on the drone.

9. The system of claim 1, further comprising:
a ground unit operatively coupled to the tether,
wherein the fixed reference frame is a ground unit-fixed reference frame, and the force parameter exerted by the tether is exerted on the ground unit.

10. The system of claim 9, wherein the ground unit at least one of provides power to the drone through the tether, receives data from the drone through the tether, transmits the data received from the drone to a user device, or moves relative to an Earth-fixed reference frame.

11. A method of controlling a drone, comprising:
manipulating a proximal end of a tether having a distal end operatively coupled to the drone;
measuring a force parameter exerted by the tether in each of three mutually orthogonal axes of a fixed reference frame;
generating one or more control parameters based at least in part on the force parameter exerted by the tether in each of the three mutually orthogonal axes; and
controlling at least one of an attitude and a position of the drone based at least in part on the one or more control parameters.

12. The method of claim 11, wherein the one or more control parameters includes one or more of a roll angle, a roll rate, a pitch angle, a pitch rate, a yaw angle, a yaw rate, and an amount of thrust.

13. The method of claim 11, further comprising:
generating a propulsion parameter based on the one or more control parameters; and
providing the propulsion parameter to a propulsion unit of the drone.

14. The method of claim 11, further comprising:
determining the attitude, the position, or both the attitude and the position of the drone relative to an Earth-fixed reference frame; and
correcting for an effect of the attitude, the position, or both the attitude and the position of the drone on the force parameters.

15. The method of claim 14, wherein correcting for the effect of the attitude, the position, or both the attitude and the position of the drone on the force parameter comprises:
generating one or more corrected force parameters that account for the effect of the attitude, the position, or both the attitude and the position of the drone on the force parameters; and
generating one or more control parameters based at least in part on the one or more corrected force parameters.

16. The method of claim 11, wherein the fixed reference frame is a drone-fixed reference frame, and the force parameter exerted by the tether is exerted on the drone.

17. The method of claim 11, wherein the force parameter exerted by the tether is exerted on a ground unit, and the fixed reference frame is a ground unit-fixed reference frame.

18. The method of claim 11, further comprising at least one of:
providing power to the drone through the tether;
receiving data from the drone through the tether;
transmitting the data received from the drone to a user device; and
moving the proximal end of the tether relative to an Earth-fixed reference frame.

19. The method of claim 11, further comprising:
determining the attitude, the position, or both the attitude and the position of the drone relative to an Earth-fixed reference frame; and
controlling the at least one of the attitude and the position of the drone using a control scheme that controls the drone based on the position of the drone relative to the Earth-fixed reference frame when the drone is hovering, and that controls the drone based on the force parameters exerted on the drone in each of the three mutually orthogonal axes when the drone is moving.

20. A computer program product for controlling a drone using a tether, comprising:
a non-transitory computer-readable storage medium; and
program code stored on the non-transitory computer-readable storage medium that, when executed by one or more processors, causes the one or more processors to:
measure a force parameter exerted by the tether in each of three mutually orthogonal axes of a fixed reference frame;
generate one or more control parameters based at least in part on the force parameter exerted by the tether in each of the three mutually orthogonal axes; and
control at least one of an attitude and a position of the drone based at least in part on the one or more control parameters.
